(19) United States
(12) Patent Application Publication
(10) Pub. No.: US 2009/0156317 A1
(43) Pub. Date: Jun. 18, 2009

(54) Automotive Drive Train Having a Four-Cylinder Engine

(76) Inventors: Mario Degler, Baden-Baden (DE); Stephen Maienschein, Baden-Baden (DE); Jan Loxtermann, Baden-Baden (DE); Thorsten Krause, Buehl (DE)

Correspondence Address: SIMPSON & SIMPSON, PLLC, 5555 MAIN STREET, WILLIAMSVILLE, NY, 14221-5406, US

(21) Appl. No.: 12/084,741

(22) PCT Filed: Oct. 16, 2006
(86) PCT No.: PCT/DE2006/001816

§ 371 Date: May 9, 2008

(30) Foreign Application Priority Data
Nov. 10, 2005 (DE) 10 2005 053 605.0

(51) Int. Cl. F16F 15/121

(52) U.S. Cl. 464/81

(57) ABSTRACT

The invention relates to an automotive drive train having an internal combustion engine that is configured as a four cylinder engine and a hydrodynamic torque converter device. The device has torsional vibration damper consisting of two energy accumulating devices and a converter lockup clutch. Turbine is interposed between the two energy accumulating devices. The mass moment of inertia J₁ should be high between the two energy accumulating devices and masses should be as little as possible between the torsional vibration damper and the transmission input shaft.

### CROSS-REFERENCE TO RELATED APPLICATIONS

This application is the National Stage of PCT International Application No. PCT/DE2006/001816, filed Oct. 16, 2006, which application published in German and is hereby incorporated by reference in its entirety, which application claims priority from German Patent Application No. 10 2005 053 605.0, filed Nov. 10, 2005 which is incorporated by reference in its entirety.

### FIELD OF THE INVENTION

The invention relates to an automotive drive train having a combustion engine configured as a 4-cylinder engine, wherein the motor vehicle drive train comprises a torque converter device, comprising a torque converter lockup clutch, a torsion vibration damper, and a converter torus, formed by a pump shell, a turbine shell, and a stator shell, wherein the torsion vibration damper furthermore comprises a first energy accumulator means and a second energy accumulator means, and wherein between the first and second energy a accumulator means, a first component is provided, which is connected in series with the two energy accumulator means, and wherein the turbine shell comprises an outer turbine dish, which is connected nonrotatably to the first component.

### BACKGROUND OF THE INVENTION

From DE 103 58 901 A1, a torque converter device is known, which comprises a converter lockup clutch, a torsion vibration damper, and a converter torus formed by a pump shell, a turbine shell and a stator shell, and wherein the torque converter device is obviously intended for a motor vehicle drive train. In the embodiments according to FIGS. 1, 4 and 5 of DE 103 58 901 A1, furthermore between a first and a second energy accumulator means of the torsion vibration damper, a first component is apparently provided, which is connected in series with the two energy accumulator means and connected nonrotatably to the outer turbine dish of the turbine shell.

### SUMMARY OF THE INVENTION

It is an object of the invention to configure a motor vehicle drive train comprising a 4-cylinder engine and a torque converter device, so it is well suited for motor vehicles with respect to its vibration properties, or torsion vibration properties, so that the motor vehicles provide convenient driving comfort.

According to the present invention, a motor vehicle drive train is proposed.

Thus, a motor vehicle drive train is proposed in particular, which comprises a 4-cylinder engine or a combustion engine configured as 4-cylinder engine. The combustion engine or the 4-cylinder engine has a maximum engine torque M_{mot,max}. The motor vehicle drive train furthermore comprises an engine output shaft or a crank shaft and a transmission input shaft. Furthermore, the motor vehicle train comprises a torque converter device. The torque converter device comprises a converter housing, which is coupled nonrotatably to the engine output shaft, or to the crank shaft. Furthermore, the torque converter device comprises a converter lockup clutch, a torsion vibration damper and a converter torus formed by a pump shell, a turbine shell and a stator shell. The torsion vibration damper comprises a first energy accumulator means and a second energy accumulator means connected in series with the first energy accumulator means. The first energy accumulator means comprises at least one first energy accumulators, or it is formed by at least one first energy accumulators, and the second energy accumulator means comprises at least one second accumulators, or it is formed by at least one second accumulators. Between the first and the second energy accumulator means, a first component is provided, which is connected in series with the two energy accumulator means. This is done in particular, so that a torque can be transferred from the first energy accumulator means through the first component to the second energy accumulator means.

It is appreciated that a means, which is designated as “converter torus”, in this application is sometimes designated as “(hydrodynamic torque) converter”. In prior applications, the term “(hydrodynamic torque) converter”, however, is also partially used in prior applications for devices, which comprise a torsion vibration damper, a converter lockup clutch and a means formed by a pump shell, a turbine shell and a stator shell, or according to the language of the present disclosure a converter torus. With this background, the terms “(hydrodynamic) torque converter device” and “converter torus” are used in the present disclosure for reasons of clarity.

The turbine shell comprises an outer turbine dish, which is connected nonrotatably to the first component. Furthermore, the torque converter device comprises a third component, which is preferably connected nonrotatably to the transmission input shaft, which in particular abuts to the torque converter device. In one embodiment, the third component is directly coupled to the transmission input shaft, in particular coupled nonrotatably. However, in an alternate embodiment, the third component is coupled to the transmission input shaft through one or several components connected in between, preferably nonrotatably coupled. The third component is connected in series to the second energy accumulator means and to the transmission input shaft, so that torque can be transferred from the second energy accumulator means through the third component to the transmission input shaft. The third component is thus disposed in particular between the second energy accumulator means and the transmission input shaft.

When transferring a torque through the first component, a change of the torque, which is transferred through the first component, is counteracted by a first mass moment of inertia. The first mass moment of inertia thus is also comprised in particular of the mass moment of inertia of the first component and of the mass moments of inertia of one or several possibly additional components, which are coupled to the first component, so that their respective mass moment of inertia also counteracts a change of the torque transfer through the first component, when transferring a torque through the first component. Such couplings can e.g. be nonrotatable couplings, in particular with reference to a rotation about the rotation axis of the torsion vibration damper. It was discussed supra, that the first mass moment of inertia during the transmission of a torque through the first component counteracts a change of the torque transferred through the first component. Preferably, when no torque is transferred through the first component, the first mass moment of inertia counteracts the transfer of a torque through the first component. The first component preferably is a flange or a plate, wherein it is provided in particular, that the outer turbine dish and/or an inner turbine dish and/or blades or a blade assembly of the turbine shell or of the turbine is a component, or an assembly of several components, which is (are) coupled to the first component, so that its mass moment(s) of inertia add(s) to the mass moment of inertia of the first component and thus in particular respectively as a summand of several summands.

When transferring a torque through the third component, a second mass moment of inertia counteracts a change of the torque transferred through the third component. The second mass moment of inertia thus is comprised in particular of the mass moment of inertia of the third component and the mass moments of inertia of one or several respective additional components, which are coupled to the third component, so that their respective mass moment of inertia counteracts the transfer of a torque through the third component when the torque transferred through the third component changes. Such couplings can e.g. be nonrotatable couplings, in particular with reference to a rotation about the rotation axis of the torsion vibration damper. Previously it was discussed, that the second mass moment of inertia when transferring a torque through the third component counteracts a change of the torque transferred through the third component. It is appreciated that it is provided in particular, that when no torque is transferred through the third component, the second mass moment of inertia counteracts the transfer of a torque through the third component.

It is provided that the motor vehicle drive train, or the torque converter device, or the torsion vibration damper, or the first energy accumulator means is configured, so that the spring constant, measured in the units of Nm/°, of the first energy accumulator means is greater than or equal to the product of the maximum engine torque, measured in the unit Nm, of the 4-cylinder engine and the factor of 0.014 [1/°] and less than or equal to the product of the maximum engine torque of the 4-cylinder engine and the factor 0.068 [1/°]. Put into an equation, this means:

(M_{mot,max}[Nm]*0.014*1/°)≦c₁≦(M_{mot,max}[Nm]*0.068*1/°),

wherein M_{mot,max} [Nm] is the maximum engine torque of the combustion engine or of the 4-cylinder engine of the drive train in the unit “Newton times meter” (Nm), and wherein c₁ is the spring constant of the first energy accumulator means in the unit “Newton times meter divided by degrees” (Nm/°).

It is furthermore provided, that the motor vehicle drive train, or the torsion vibration damper or the second energy accumulator means is configured, so that the spring constant [in the unit Nm/°] of the second energy accumulator means is greater than or equal to the product of maximum engine torque [in the unit Nm] of the 4-cylinder engine and the factor 0.035 [1/°] and smaller than or equal to the product of the maximum engine torque [in the unit Nm] of the 4-cylinder engine and the factor 0.158 [1/°]. Put into an equation, this means:

(M_{mot,max}[Nm]*0.035*1/°)≦c₂≦(M_{mot,max}[Nm]*0.158*1/°),

wherein M_{mot, max} [Nm] is the maximum engine torque of the combustion engine or of the 4-cylinder engine of the drive train in the unit “Newton times meter” (Nm), and wherein c₂ is the spring constant of the second energy accumulator means in the unit “Newton times meter divided by degrees” (Nm/°).

It is furthermore provided, that the motor vehicle drive train or the torque converter device or the torsion vibration damper is configured, so that the quotient, which on the one hand is formed by the sum of the spring constant of the first energy accumulator means [in the unit Nm/rad], and the spring constant of the second energy accumulator means [in the unit Nm/rad] and, on the other hand, by the first mass moment of inertia [in the unit of kg*m²], is greater than or equal to 14037 N*m/(rad*kg*m²), and less than or equal to 49348 N*m/(rad*kg*m²). Thus, put into an equation it is provided:

14037 N*m/(rad*kg*m²)≦(c₁+c₂)/J₁≦49348N*m/(rad*kg*m²),

wherein c₁=spring constant of the first energy accumulator means [in the unit Nm/rad], and wherein c₂=spring constant of the second energy accumulator means [in the unit Nm/rad], and wherein J₁=first mass moment of inertia [in the unit kg*m²]. The abbreviation “rad” designates the radian measure.

It is furthermore provided that the motor vehicle drive train or the torque converter device or the torsion vibration damper or the transmission input shaft are configured, so that the quotient, which is on the one hand formed by the sum of the spring constant of the second energy accumulator means [in the unit Nm/rad] and the spring constant of the transmission input shaft [in the unit Nm/rad] and on the other hand of the second mass moment of inertia [in the unit kg*m²] is greater than or equal to 1403677 N*m/(rad*kg*m²) and less than or equal to 5614708 N*m/(rad*kg*m²). Thus this reads as an equation:

1403677 N*m/(rad*kg*m²)≦(c₂+c_{GEW})/J₂≦5614708 N*m/(rad*kg*m²),

wherein c₂=spring constant of the second energy accumulator means [in the unit Nm/rad] and c_{GEW}=spring constant of the transmission input shaft [in the unit Nm/rad], and J₂=the second mass moment of inertia [in the unit kg*m²].

According to a preferred embodiment, it is thus provided that the transmission input shaft is configured, so that the spring constant of the transmission input shaft is greater than or equal to 100 Nm/°, and less than or equal to 350 Nm/°. Thus, put into an equation the following applies preferably: 100 Nm/°≦c_{GEW}≦350 Nm/°, wherein c_{GEW}=spring constant of the transmission input shaft [in the unit Nm/°]. The following applies in particular: 120 Nm/°≦c_{GEW}≦300 Nm/°. According to another preferred embodiment the following applies: 120 Nm/°≦c_{GEW}≦210 Nm/°. According to another preferred embodiment the following applies: 130 Nm/°≦c_{GEW}≦150 Nm/°. It is preferred in particular, that the spring constant c_{GEW} of the transmission input shaft is approximately in a range of 140 N*m/° or is 140 N*m/°. These values of the spring constant c_{GEW} of the transmission input shaft relate in particular to a torsion loading or to a torsion loading about the central longitudinal axis of the transmission input shaft, or the spring constant c_{GEW} of the transmission input shaft is the spring constant of the transmission input shaft, which is effective or present or occurs under a torsion loading or under a torsion loading about the central longitudinal axis of the transmission input shaft. The transmission input shaft is supported rotatable and thus about its central longitudinal axis or rotation axis.

It is thus provided in particular that the torsion vibration damper is rotatable about a rotation axis of the torsion vibration damper. The rotation axis of the torsion vibration damper corresponds in an advantageous embodiment to the rotation axis of the transmission input shaft.

Preferably, a second component, which is e.g. configured as a plate or as a flange, is provided, which is connected in series with the first energy accumulator means and the first component. Thus, it is provided in particular, that the first energy accumulator means is disposed between the second component and the first component, so that a torque is transferable from the second component through the first energy accumulator means to the first component. The second component is thus preferably provided between the converter lockup clutch and the first energy accumulator means, so that, when the converter lockup clutch is closed, a torque transferred through the converter lockup clutch can be transferred through the second component to the first energy accumulator means. The converter lockup clutch can be connected to the converter housing torque proof, or in a solid manner, so that when the converter lockup clutch is closed, a torque from the converter housing can be transferred through the converter lockup clutch. The converter lockup clutch can e.g. be configured as multidisc clutch. Thus, it can comprise a press component or an e.g. axially movable and e.g. hydraulically loadable piston, by means of which the multidisc clutch can be closed. Thus, for example, it can be provided that the second component is the press component or the piston of the multidisc clutch or connected nonrotatably to the press component or the piston.

The first component is a plate or a flange in a preferred embodiment. The third component is a plate or a flange in a preferred embodiment. The third component can form e.g. a hub or it can be coupled nonrotatably to a hub. This hub can, for example be coupled nonrotatably to the transmission input shaft, or it can engage nonrotatably with the transmission input shaft.

It is preferably provided that the second component or a component connected nonrotatably therewith forms an input component of the first energy accumulator means. It can be provided in particular, that the second component or a component coupled nonrotatably therewith, engages in particular on the input side with the first energy accumulators of the first energy accumulator means or engages with first face sides of the first energy accumulator means. It is provided in particular, that the first component or a component connected nonrotatably to the first component, and thus in particular on the output side, engages with the first energy accumulators of the first energy accumulator means, or with second front faces, which are different from the first front faces, of the first energy accumulators of the first energy accumulator means. It is furthermore provided in particular that the first component, or possibly an additional component, connected nonrotatably with the first component and in particular on the input side engages with the second energy accumulator of the second energy accumulator means, or with the first front faces of the second energy accumulators of the second energy accumulator means. Furthermore it is provided in particular that the third component or a component connected nonrotatably with the third component and in particular on the output side engages with the second energy accumulators of the second energy accumulator means, or engages with second front faces, which are different from the first front faces of the second energy accumulator means.

According to a preferred embodiment, the first energy accumulator means comprises at least one first energy accumulators. The first energy accumulators are coil springs or arc springs according to a preferred embodiment. It can be provided that all of the first energy accumulators are connected in parallel. According to an improved embodiment, the first energy accumulator(s) are disposed, distributed, or offset about the circumference with circumference referring to the circumferential direction of the rotation axis of the torsion vibration damper. However, in an alternate improved embodiment, several first energy accumulators may be disposed, distributed, or offset about the circumference with reference to the circumferential direction of the rotation axis of the torsion vibration damper, wherein the energy accumulators, which are disposed distributed or offset about the circumference are configured as arc springs or as coil springs, and receive, respectively, one or several additional first energy accumulators in their interior. In an embodiment of the latter type, it can be provided that when loading the first energy accumulator means, gradually increasing the load from the unloaded state, initially only those first energy accumulators store energy, which receive one or several first energy accumulators in their interior and which store energy in the first energy accumulator, received in the interior, when the load on the first energy accumulator means is above a predetermined threshold load, or above a predetermined threshold torque, or vice versa.

According to a preferred embodiment, the second energy accumulator means comprises several second energy accumulators. The second energy accumulators, according to a preferred embodiment, are at least one coil spring or compression spring or straight spring. In one embodiment, all the second energy accumulators are connected in parallel. According to an improved embodiment, the at least one second energy accumulators are disposed distributed, or offset about the circumference with reference to the circumferential direction of the rotation axis of the torsion vibration damper. However, in an alternate embodiment, a plurality of second energy accumulators are disposed, distributed, or offset about the circumference with reference to the circumferential direction of the rotation axis of the torsion vibration damper, wherein the second energy accumulators which are disposed distributed or offset about the circumference are provided as compression springs or as straight springs or as coil springs and receive one or several additional second energy accumulators in their interior. In the alternate embodiment, it can be provided that under a loading, which gradually increases from the unloaded state of the second energy accumulator means, initially only those second energy accumulators accumulate energy, which receive one or several additional second energy accumulators in their interior, and the second energy accumulator received in the interior only store energy when the loading of the second energy accumulator means is above a predetermined threshold loading or above a predetermined threshold torque or vice versa.

Preferably, the first energy accumulators are disposed, or the first energy accumulator means is disposed radially outside of the second energy accumulators or of the second energy accumulator means. This relates in particular to the radial direction of the rotation axis of the torsion vibration damper.

The spring constant of the first energy accumulator means is in particular the spring constant, or the combined spring constant, which is effective at torque loads of the first energy accumulator means and thus in particular under torque loads, which act about the rotation axis of the torsion vibration damper upon the first energy accumulator means. The spring constant of the first energy accumulator means is determined in particular by the spring constants of the first energy accumulators and their disposition and their connection. The spring constant of the first energy accumulator means is thus in particular a combined spring constant, which is determined by the spring constants of the first energy accumulators and their arrangement or their connection. As discussed, the first energy accumulators are connected in parallel in a preferred embodiment. However, it can also be provided for example that the first energy accumulators are connected, so that they basically form a parallel assembly, wherein first energy accumulators are connected in series in the parallel paths of this parallel assembly thus formed.

The spring constant of the second energy accumulator means is in particular the spring constant or the combined spring constant, which is effective or given or occurs under torque loadings of the second energy accumulator means, and thus in particular under torque loadings, which impact the second energy accumulator means about the axis of rotation of the torsion vibration damper. The spring constant of the second energy accumulator means is determined in particular by the spring constants of the second energy accumulators and their disposition or connection. The spring constant of the second energy accumulator means is thus in particular a combined spring constant, which is defined by the spring constants of the second energy accumulators and their disposition or their connection. As described, the second energy accumulators are connected in parallel in an advantageous embodiment. However, it can also be provided, e.g. that second energy accumulators are connected, so that they basically form a parallel connection, wherein second energy accumulators are connected in series in the parallel paths of the parallel assembly.

The first mass moment of inertia particularly relates to the rotation axis of the torsion vibration damper. The first component is, for example, a plate. It can be provided that the outer turbine dish is connected nonrotatably to the first component by means of one or more driver components. Thus, it is provided in particular that the mass moment of inertia of such driver component(s) determine(s) or co-determine(s) the first mass moment of inertia and is thus a summand. It is provided in particular that the mass moments of inertia of the components, in particular of the first component, or of the component, through which a torque is transferred from the first energy accumulators of the first energy accumulator means to the to the second energy accumulators of the second energy accumulator means, or which are connected between the first energy accumulators of the first energy accumulator means and the second energy accumulators of the second energy accumulator means determine or co-determine the first mass moment of inertia. The mass moments of inertia respectively relate in particular to the rotation axis of the torsion vibration damper.

The second mass moment of inertia relates to the rotation axis of the torsion vibration damper in particular. The third component is, for example, a plate.

Preferably the motor vehicle drive train or the torque converter device or the torsion vibration damper or the first energy accumulator means are configured so that the following applies:

(M_{mot,max}[Nm]*0.02*1/°)≦c₁≦(M_{mot,max}[Nm]*0.06*1/°);

or the following applies:

(M_{mot,max}[Nm]*0.03*1/°)≦c₁≦(M_{mot,max}[Nm]*0.05*1/°).

Preferably the motor vehicle drive train or the torque converter device or the torsion vibration damper or the second energy accumulator means are configured so that the following applies:

(M_{mot,max}[Nm]*0.04*1/°)≦c₂≦(M_{mot,max}[Nm]*0.15*1/°); or the following applies:

(M_{mot,max}[Nm]*0.05*1/°)≦c₂≦(M_{mot,max}[Nm]*0.13*1/°); or the following applies:

(M_{mot,max}[Nm]*0.06*1/°)≦c₂≦(M_{mot,max}[Nm]*0.1*1/°).

Preferably the motor vehicle drive train or the torque converter device or the torsion vibration damper is configured, so that the following applies:

17000 N*m/(rad*kg*m²)≦(c₁+c₂)/J₁≦46000 N*m/(rad*kg*m²);

or so that the following applies:

20000 N*m/(rad*kg*m²)≦(c₁+c₂)/J₁≦43000 N*m/(rad*kg*m²);

or so that the following applies:

23000 N*m/(rad*kg*m²)≦(c₁+c₂)/J₁≦40000 N*m/(rad*kg*m²).

Preferably the motor vehicle drive train or the converter device or the torsion vibration damper or the transmission input shaft are configured, so that the following applies:

1800000 N*m/(rad*kg*m²)≦(c₂+c_{GEW})/J₂≦5200000 N*m/(rad*kg*m²);

or so that the following applies:

2200000 N*m/(rad*kg*m²)≦(c₂+c_{GEW})/J_{2≦4800000} N*m/(rad*kg*m²);

or so that the following applies:

2400000 N*m/(rad*kg*m²)≦(c₂+c_{GEW})/J₂≦4400000 N*m/(rad*kg*m²);

or so that the following applies:

2800000 N*m/(rad*kg*m²)≦(c₂+c_{GEW})/J₂≦4000000 N*m/(rad*kg*m²).

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1a schematic view of an exemplary motor vehicle drive train;

FIG. 2 a section of an exemplary motor vehicle drive train according to the invention, comprising a first exemplary hydrodynamic torque converter device;

FIG. 3 a section of an exemplary motor vehicle drive train according to the invention comprising a second exemplary hydrodynamic torque converter device;

FIG. 4 a section of an exemplary motor vehicle drive train comprising a third hydrodynamic torque converter device; and,

FIG. 5 a spring rotating mass schematic of a section of an exemplary motor vehicle drive train for the case of the closed converter lockup clutch.

### DETAILED DESCRIPTION OF PREFERRED EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

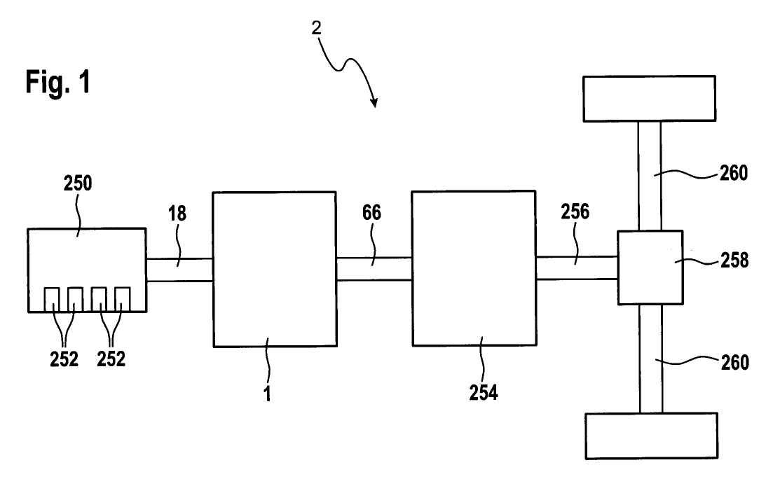

FIG. 1 shows an exemplary motor vehicle drive train 2 according to the invention in a schematic illustration. The motor vehicle drive train 2 comprises a combustion engine 250 and a drive shaft or an engine output shaft or crank shaft 18, which can be driven by the combustion engine 250 in a rotating manner. The combustion engine 250 comprises 4 cylinders 252, or it is a 4-cylinder engine 250. The 4-cylinder engine 250 comprises a maximum engine torque M_{mot,max}, or it can impart a maximum torque into the drive train 2, which corresponds to the maximum engine torque M_{mot,max}.

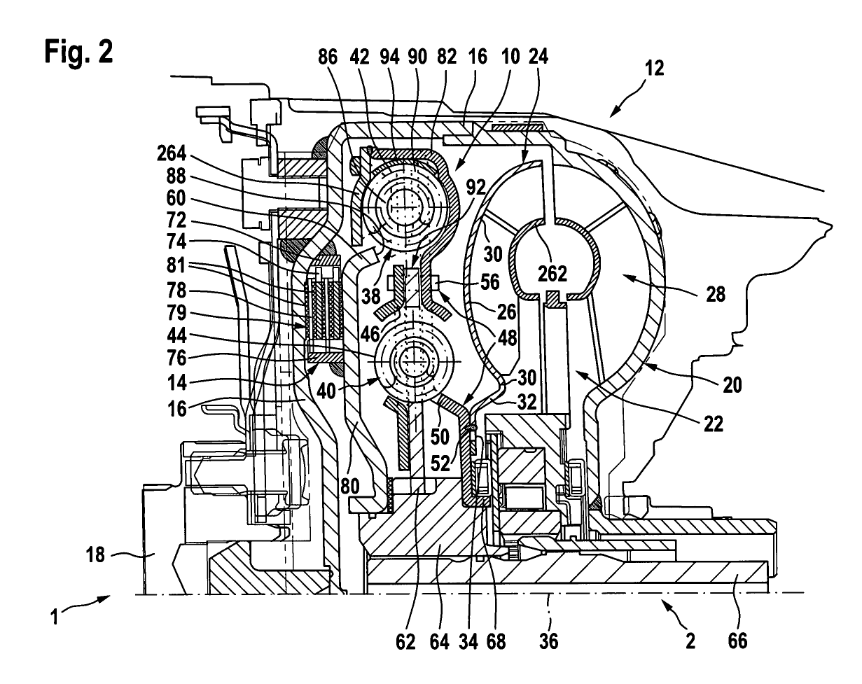

The motor vehicle drive train 2 comprises a hydrodynamic torque converter device 1, which is configured according to one of the embodiments, which are described with reference to FIGS. 2 through 4.

The motor vehicle drive train 2 furthermore comprises a transmission 254, which is, for example, an automatic transmission. Furthermore, the motor vehicle drive train 2 can comprise a transmission output shaft 256, a differential 258 and one or several drive axles 260. The motor vehicle drive train 2 furthermore comprises a transmission input shaft 66 between the torque converter device 1 and the transmission 254. The torque converter device 1, or a component like the hub 64 of the torque converter device 1 is connected nonrotatably to the transmission input shaft 66. The engine output shaft or the crank shaft 18 is coupled nonrotatably to the converter housing 16 of the torque converter device 1. Thus a torque can be transferred from the drive shaft or the engine output shaft or the crank shaft 18 through the torque converter device 1 to the transmission input shaft 66.

The FIGS. 2 through 4 show various exemplary hydrodynamic torque converter devices 1, which can be provided in an exemplary motor vehicle drive train 2 according to the invention, or in the motor vehicle drive train 2, according to FIG. 1. The embodiments illustrated in FIGS. 2 through 4 are components of an exemplary motor vehicle drive train 2 according to the invention, which comprises a 4-cylinder engine 250, which is not shown in the FIGS. 2 through 4, or a combustion engine 250, which is not shown in the FIGS. 2 through 4, which is configured as 4-cylinder engine and thus comprises 4 cylinders 252. The hydrodynamic torque converter device 1 comprises a torsion vibration damper 10 and a converter torus 12 formed by a pump shell 20, a turbine shell 24 and a stator shell 22, and comprises a converter lockup clutch 14.

The torsion vibration damper 10, the converter torus 12, and the converter lockup clutch 14 are received in a converter housing 16. The converter housing 16 is connected substantially nonrotatably to a drive shaft 18, which is in particular the crank shaft or the engine output shaft of a combustion engine.

As discussed, the converter torus 12 comprises a pump or a pump shell 20, a stator shell 22 and a turbine or a turbine shell 24, which interact in a known manner. In a known manner, the converter torus 12 comprises a converter torus cavity or a torus interior 28, which is provided for receiving oil or for an oil flow. The turbine shell 24 comprises an outer turbine dish 26, which forms a wall section 30, which directly abuts to the torus interior 28 and which is provided for defining the torus interior 28. Furthermore, the turbine shell 24 comprises an inner turbine dish 262 and turbine blades in a known manner. An extension 32 of the outer turbine dish 26 connects to the wall section 30 directly abutting to the torus interior 28. The extension 32 comprises a straight or annular section 34. The straight or annular section 34 of the extension 32 can e.g. be configured, so that it is substantially straight in radial direction of the axis of rotation 36 of the torsion vibration damper 10, and disposed in particular as an annular section in a plane disposed perpendicular to the rotation axis 36, or so that it defines the plane.

The torsion vibration damper 10 comprises a first energy accumulator means 38 and a second energy accumulator means 40. In the embodiment shown, the first energy accumulator means 38 and the second energy accumulator means 40 are both spring means in particular.

In the embodiments according to FIGS. 2 through 4 it is provided that the first energy accumulator means 38 comprises several first energy accumulators 42, or that it is comprised of the energy accumulators, like e.g. coil springs or arc springs, offset from one another in a circumferential direction extending about the axis of rotation 36. In one embodiment, all first energy accumulators 42 are configured identically. In an alternate embodiment, differently configured first energy accumulators 42 are provided.

The spring constant c₁, measured in the unit Nm/°, of the first energy accumulator means 38 is greater than or equal to the product of the maximum engine torque M_{mot,max}, measured in the unit Nm] of the 4-cylinder engine 250 and the factor 0.014 [1/°] and less than or equal to the product of the maximum engine torque in units Nm of the 4-cylinder engine 250 and the factor 0.068 [1/°]. Thus the following applies:

(M_{mot,max}[Nm]*0.014*1/°)≦c₁≦(M_{mot,max}[Nm]*0.068*1/°),

wherein M_{mot,max} [Nm] is the maximum engine torque of the combustion engine or of the 4-cylinder engine 250 of the drive train 2 measured in the unit “Newton times meter” (Nm), and wherein c₁ is the spring constant of the first energy accumulator means 38 in the unit “Newton meter divided by degrees” (Nm/°). The values or ranges however can be also disposed as described at another location of the present disclosure.

The second energy accumulator means 40 comprises plural second energy accumulators 44, respectively configured as coil springs or compression springs or straight springs, or it is formed by the second energy accumulators 44. Thus, in a preferred embodiment, several second energy accumulators 44 are disposed offset from one another relative to the circumferential direction of the rotation axis. In one embodiment, the second energy accumulators 44 are respectively configured identically. In an alternate embodiment, second energy accumulators 44 however can also be configured differently.

The spring constant c₂ [in the unit Nm/°] of the second energy accumulator means 40 is greater than or equal to the product of the maximum engine torque M_{mot,max} [in the unit Nm] of the 4-cylinder engine 250 and the factor 0.035 [1/°] and less than or equal to the product of the maximum engine torque M_{mot,max}[in the unit Nm] of the 4-cylinder engine 250 and the factor 0.158 [1/°]. Thus, the following applies:

(M_{mot,max}[Nm]*0.035*1/°)≦c₂≦(M_{mot,max}[Nm]*0.158*1/°),

wherein M_{mot,max} [Nm] is the maximum engine torque of the combustion engine or the 4-cylinder engine 250 of the drive train 2 in the unit “Newton times meter” (Nm), and wherein c₂ is the spring constant of the second energy accumulator means in the unit “Newton times meter divided by degrees” (Nm/°). The values or ranges however can be also disposed as described at another location of the present disclosure.

According to the embodiments seen in FIGS. 2 through 4, the second energy accumulator means 40 is disposed with reference to the radial direction of the rotation axis 36 radially within the first energy accumulator means 38. The first energy accumulator means 38 and the second energy accumulator means 40 are connected in series. The torsion vibration damper 10 comprises a first component 46, which is disposed between the first energy accumulator means 38 and the second energy accumulator means 40, or connected in series with the first energy accumulator means 38 and second accumulator means 40. It is also provided in particular, for example, when the lockup clutch 14 is closed, that a torque can be transferred from the first energy accumulator means 38 through the first component 46 to the second energy accumulator means 40. The first component 46 can also be designated as intermediary component 46, which is also done infra.

It is provided in the embodiments according to FIGS. 2 through 4, that the outer turbine dish 26 is connected to the intermediary component 46, so that a load, in particular torque and/or force, can be transferred from the outer turbine dish 26 to the intermediary component 46.

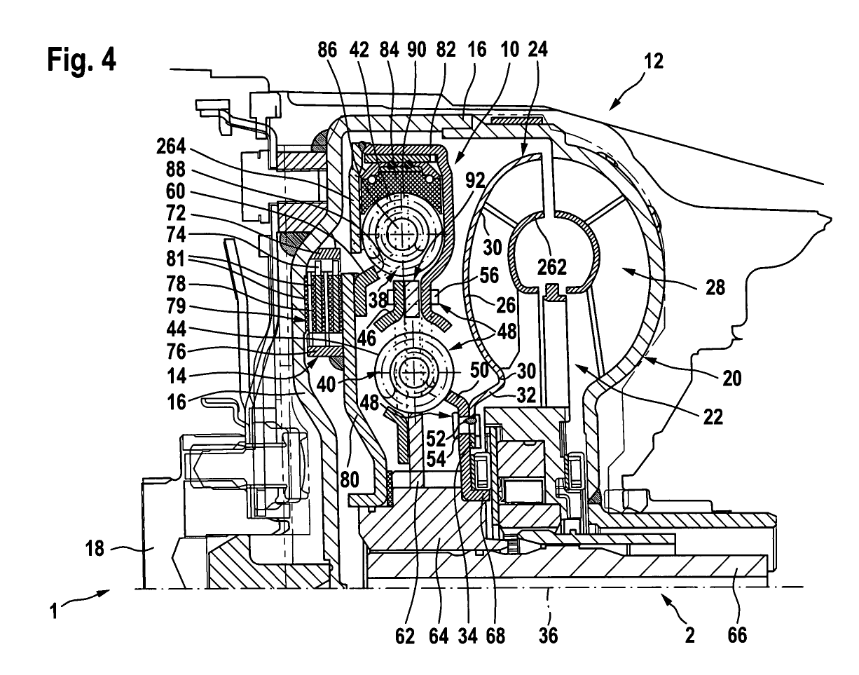

Between the outer turbine dish 26 and the intermediary component 46, or in the load flow, in particular in the torque or force flow between the outer turbine dish 26 and the intermediary component 46, a driver component 50 is provided. In one embodiment, the extension 32 also forms the intermediary component 46 and/or the driver component 50, or takes over their function. In an alternate embodiment, the driver component 50 forms a first component or an intermediary component, which is connected in series in the torque flow between the first energy accumulator means 38 and the second accumulator means 40. It is furthermore provided that along the load transfer path 48, through which a load or a torque can be transferred from the outer turbine dish 26 to the intermediary component 46, at least one connection means 52, 56 and/or 54 is provided. Such a connection means 52, 56, or 54 can e.g. be a plug-in connection or a rivet connection, or a bolt connection (see reference numeral 56 in FIGS. 2 through 4) or a weld (see reference numeral 52 in FIGS. 2 through 4) or similar connection known to those skilled in the art. It is appreciated that in FIG. 4 at the location where the weld 52 is provided, an additional rivet or bolt connection 52 is drawn, in order to show an alternative configuration. This is also intended to clarify that the connection means can also be configured differently or can be combined differently. By the respective connection means 52, 54, and/or 56, respective adjoining components of the load transfer path 48, through which the load can be transferred from the outer turbine dish 26 to the intermediary component 46, are coupled amongst one another. Thus, the extension 32 of the outer turbine dish 26 is coupled in the embodiments according to FIGS. 2 through 4 with the driver component 50 respectively nonrotatable by a connection means 52 configured as a weld (which can also alternatively be a rivet or bolt connection according FIG. 4) and the driver component 50 is coupled nonrotatably to the intermediary component 46 through a connection means 56, respectively configured as a rivet or bolt connection.

It is provided that all connection means 52, 54, and 56, by which components adjoining along the load transfer path 48 between the outer turbine dish 26 and the intermediary component 46, like, for example, the extension 32 and the driver component 50 or the driver component 50 and the intermediary component 46, are connected, are offset from the wall section 30 of the outer turbine dish 26 directly adjoining to the torus interior 28. This facilitates at least according to the embodiments, that the number of possible connection means can be increased. Thus it is possible e.g. that not only thin plate- or MAG- or Laser- or dot welding is used as welding method, but also e.g. friction welding.

A second component 60 and a third component 62 are connected in series with the first energy accumulator means 38, the second energy accumulator means 40 and the intermediary component 46 provided between the two energy accumulator means 38, 40. The second component 60 forms an input component of the first energy accumulator means 38 and the third component 62 forms an output component of the second energy accumulator means 40. A load or a torque transferred by the second component 60 into the first energy accumulator means 38 can thus be transferred on the output side of the first energy accumulator means 38 through the intermediary component 46 and the second energy accumulator means 40 to the third component 62.

The third component 62 engages the hub 64, forming a nonrotatable connection, which is in turn coupled nonrotatably to an output shaft 66 of the torque converter device 1, which is e.g. a transmission input shaft 66 of a motor vehicle transmission. In an alternate embodiment, the third component 62 may form the hub 64. The outer turbine dish 26 is radially supported at the hub 64 by means of a support section 68. The support section 68, which is in particular radially supported at the hub 64, is substantially configured as a sleeve.

It is appreciated that the radial support of the outer turbine dish 26 by means of the support section 68 is configured, so that support forces acting upon the outer turbine dish 26 through support section 68 are not conducted through the first energy accumulator means 38 or the second energy accumulator means 40 from the support section 68 to the outer turbine dish 26. The support section 68 is rotatable relative to the hub 64. It can be provided, that a straight bearing or a straight bearing bushing, or a roller bearing, or similar is provided for radial support between the hub 64 and the support section 68. Furthermore, respective bearings can be provided for axial support. The connection discussed supra between the outer turbine dish 26 and the intermediary component 46 may be configured, so that torque, which is transferable from the outer turbine dish 26 to the intermediary component 46, can be transferred without one of the energy accumulator means 38 and/or 40 being provided along the respective load transfer path 48. The torque transfer from the outer turbine dish 26 to the intermediary component 46 through the load transfer path 48 can thus be provided in particular by means of a substantially rigid connection.

In the embodiments according to FIGS. 2 through 4 two respective connection means are provided along the load/force/torque/transfer path 48 between the outer turbine dish 26 and the intermediary component 46, and thus a first connection means 52 or 54 and a second connection means 56. It is appreciated that with reference to the circumferential direction of the rotation axis 36, distributed in circumferential direction, several distributed first connection means 52 or second connection means 56 can be provided or can preferably be provided. The first connection means 52 or 54 (subsequently the “first connection means 52” is referred to for purposes of simplification) connect in particular nonrotatably the extension 32 to the driver component 50 and the second connection mean(s) 56 (subsequently referred to as the second connection means 54 for purposes of simplification) connect in particular nonrotatably the driver component 50 to the intermediary component 46.

As illustrated in FIGS. 2 through 4, the sleeve shaped support portion 68 can for example, be a radially inner section of the driver component 50 with reference to the radial direction of the rotation axis 36.

The converter lockup clutch 14 is provided in the embodiments according to FIGS. 2 through 4 as a respective multidisc clutch and comprises a first disk carrier 72, by which first disks 74 are received nonrotatably, and a second disk carrier 76 by which second disks 78 are received nonrotatably. When the multidisc clutch 14 is open, the first disk carrier 72 is movable relative to the second disk carrier 76 and thus so that the first disk carrier 72 is rotatable relative to the second disk carrier 76. The second disk carrier 76 is disposed with reference to the radial direction of the axis 36 radially within the first disk carrier 72, or, alternatively, first disk carrier 72 may be disposed within second disk carrier 76. The first disk carrier 72 is connected to the converter housing 16. For actuation, the multidisc clutch 14 comprises a piston 80, which is disposed axially movable and which can be loaded for example hydraulically for actuating the multidisc clutch 14. The piston 80 is connected in a rigid manner or nonrotatable to the second disk carrier 76, which can be effectuated e.g. by means of a welded connection. First disks 74 and second disks 78 alternate viewed in longitudinal direction of the rotation axis 36. When loading the disk packet 79 formed by the first disks 74 and the second disks 78, by means of the piston 80, the disk packet 79 is supported on the side of the disk packet 79 opposite to the piston 80 at a section of the inside of the converter housing 16. Between adjacent disks 74 and 78 and at both ends of the disk packet 79, friction liners 81 are provided, which are for example, held at the disks 74 and/or 78. The friction liners 81, which are provided at the ends of the disk packet 79, can also be supported on the one side and/or the other side also at the inside of the converter housing 16 or at the piston 80.

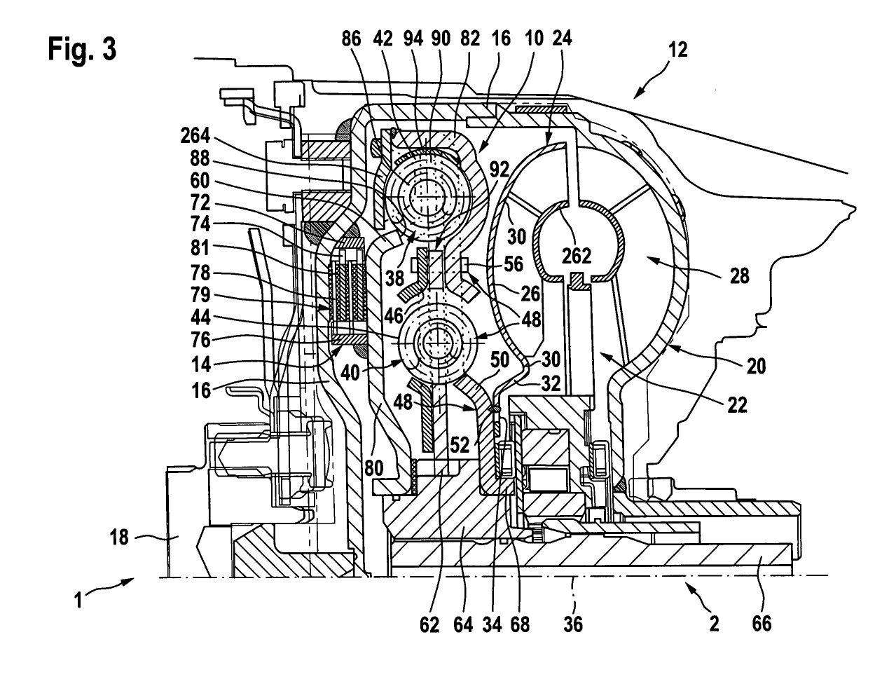

In the embodiments according to FIGS. 2 and 3, the piston 80 is integrally formed with the second component 60 and is thus the input component of the first energy accumulator means 38. In the embodiment according to FIG. 4, the piston 80 is connected nonrotatably or fixated to the second component 60 or the input component of the first energy accumulator means 38, wherein the fixation is performed is here e.g. by a weld. As a matter of principle a nonrotatable connection can also be performed in another manner, such as, for example, by using rivets or bolts. In the embodiments according to FIGS. 2 and 3, in an alternative embodiment, the piston 80 and the input component 60 of the first energy accumulator means 38 can also be provided as separate components connected amongst one another in a fixated or nonrotatable manner e.g. by a weld or a rivet or a bolt. In the embodiment according to FIG. 4, also another suitable connection can be provided between the piston 80 and the input component 60 instead of a weld, in order to generate the solid or nonrotatable connection, like e.g. a bolt or rivet joint or a plug-in connection or alternatively, the piston 80 with the input component 60 can also be manufactured integrally from one piece.

The piston 80 or the second component 60, the first component or the intermediary component 46, the driver component 50 and the third component 62 are respectively formed by plates. The second component 60 preferably may be a flange. The first component 46 is a flange preferably. The third component 62 is a flange preferably.

In the embodiment according to FIG. 3, the plate thickness of the driver component 50 is greater than the plate thickness of the piston 80, or of the input component 60 of the first energy accumulator means 38. Furthermore it can be provided in the embodiments shown in FIGS. 2 through 4, that the mass moment of inertia of the driver component 50 is greater than the mass moment of inertia of the piston 80 or of the input component 60 or of the unit made of these components 60, 80. The plate thickness of driver component 50 may be twice as thick, three times as thick, fives times as thick, ten times as thick or 20 times as thick as the plate thickness of piston 80, depending on the configurations, size and weight of the components. Alternatively, the driver component 50 may be twice as stiff, three times as stiff, five times as stiff, ten times as stiff or twenty times as stiff and the stiffness of piston 80.

For the first energy accumulators 42, a respective type of housing 82 is formed, which extends with reference to the radial direction and to the axial direction of the rotation axis 36 at least partially on both sides axially and radially on the outside about the first energy accumulator 42. In the embodiments according to FIGS. 2 through 4, the housing 82 is connected at the driver component 50. In most embodiments the nonrotatable disposition at the driver component 50 or at the outer turbine dish is more advantageous from a vibration point of view, than e.g. a nonrotatable connection at the second component 60. The housing 82 in this case comprises a cover 264, which is e.g. welded on.

In the embodiment according to FIG. 4, the first energy accumulators 42 can be supported at the housing 82 for friction reduction by a respective means 84 comprising roller bodies such as balls or rollers, which can also be designated as a roller shoe. Though this is not shown in FIGS. 2 and 3, such a device 84, comprising roller bodies like balls or rollers for supporting the first energy accumulators 42 or for friction reduction can also be accordingly provided in the embodiments according to FIGS. 2 and 3. According to FIGS. 2 and 3, however, a slider dish or a slider shoe 94 is provided here instead of such a roller shoe 84 for the low friction support of the first energy accumulators 42.

Furthermore, a second rotation angle limiter means 92 is provided for the second energy accumulator means 40 in the embodiments according to FIGS. 2 through 4, by which the maximum rotation angle or the relative rotation angle of the second energy accumulator means 40 or of the input component of the second energy accumulator means 40 relative to the output component of the second energy accumulator means 40 is limited. This is performed here, so that the maximum rotation angle of the second energy accumulator means 40 is limited by the second rotation angle limiter means 92, so that it prevents the second energy accumulators 44, which are springs in particular, from going into blockage under a respectively high torque loading. The second rotation angle limiter means 92 is configured as shown in FIGS. 2 through 4 e.g., so that the driver component 50 and the intermediary component 46 are connected nonrotatably by a bolt, which is in particular a component of the connection means 56, wherein the bolt extends through a slotted hole, which is provided in the output component of the second energy accumulator means 40 or in the third component 62. A first rotation angle limiter means can also be provided for the first energy accumulator means 38, which is not shown in the figures, by which the maximum rotation angle of the first energy accumulator means 38 is limited, so that a blockage loading of the first energy accumulators 42, which are in particular provided as respective springs, is avoided. case in, a preferred embodiment, the second energy accumulators 44 are straight compression springs and the first energy accumulators 42 are arc springs. In this preferred embodiment, as illustrated in FIGS. 2 through 4, only a second rotation angle limiter means 92 is used with the second energy accumulator means 40, since in such configurations in case of a blockage loading the risk of damaging the arc springs is lower than in case of straight springs and an additional first rotation angle limiter means will increase the number of components and/or the manufacturing cost.

In a particularly advantageous embodiment, it is provided in the configurations according to FIGS. 2 through 4, that the rotation angle of the first energy accumulator means 38 is limited to a maximum first rotation angle and the rotation angle of the second energy accumulator means 40 is limited to a maximum second rotation angle, wherein the first energy accumulator means 38 reaches its maximum first rotation angle, when a first threshold torque is applied to the first energy accumulator means 38, and so that the second energy accumulator means 40 reaches its second maximum rotation angle, when a second threshold torque is applied to the second energy accumulator means 40, wherein the first threshold torque is less than the second threshold torque. This can be performed in particular by a respective setting of the two energy accumulator means 38, 40 or of the energy accumulators 42, 44 of the first accumulator means 38 and the second energy accumulator means 40, for example by the first and/or the second rotation angle limiter means. In one embodiment, the first energy accumulators 42 go into blockage under the first threshold torque, so that the first energy accumulator means 38 reaches its maximum first rotation angle, and while with a second rotation angle limiter means 92 for the second energy accumulator means 40, the second energy accumulator means 40 reaches its maximum second rotation angle at a second threshold torque, so that the maximum second rotation angle is reached, when the second rotation angle limiter means reaches a stop position.

This way, a particularly good setting for partial load operations can be reached.

It is appreciated that the rotation angle of the first energy accumulator means 38 or of the second energy accumulator means 40, up to the maximum first or maximum second rotation angle, respectively, are thus the relative rotation angle with reference to the rotation axis 36 of the torsion vibration damper 10, which is given relative to the unloaded resting position between components adjoining one another on the input side and on the output side for a torque transfer respectively directly to the respective components adjoining the energy accumulator means 38 or 40. The rotation angle, which is limited in particular in the manner by the respective maximum first or second rotation angle, can change in particular by the energy accumulators 42 or 44 of the respective energy accumulator means 38 or 40 absorbing energy or releasing stored energy.

Oil is included in particular in the converter torus 12 and also outside of the converter torus 12 within the converter housing 16.

In the embodiments according to FIGS. 2 through 4, the piston 80, or the second component or the input component 60 of the first energy accumulator means 38 form several lugs 86, distributed about the circumference, each comprising a non-free end 88 and a free end 90, and which are provided for a face side or input side loading of the respective first energy accumulator 42. The non-free end 88 is thus disposed with reference to the radial direction of the rotation axis 36 radially within the free end 90 of the respective lug 86.

As shown in FIGS. 2 through 4, with reference to the radial direction of the axis 36 of the torsion vibration damper 10, the radial extension of the driver component 50 can be greater than the center radial distance of the first energy accumulator(s) 42 from the second energy accumulator(s) 44.

In the embodiments according to FIGS. 2 through 4, it is respectively provided that the transmission input shaft 66 is configured, so that the spring constant c_{GEW} of the transmission input shaft 66 is in the range of 100 Nm/° to 350 Nm/°. The value ranges can however also be selected, as it is described at another location of the present disclosure. The spring constant c_{GEW} of the transmission input shaft 66 is thus in particular the one, which is effective, when the transmission input shaft 66 is torsion loaded about its central longitudinal axis.

When transmitting a torque through the first component 46, a first mass moment of inertia J₁ counteracts the torque transferred through the first component 46. When transmitting a torque through the third component 62, a second mass moment of inertia J₂ acts against a change of the torque transmitted through the third component 62.

In the embodiments according to FIGS. 2 through 4, it is respectively provided that the motor vehicle drive train 2, or the torque converter device 1, or the torsion vibration damper 10 are configured, so that the quotient which is formed on the one hand from the sum (c₁+c₂) of the spring constant c₁ of the first energy accumulator means 38 measured in the unit Nm/rad, and the spring constant c₂ of the second energy accumulator means 40 also measured in the unit Nm/rad, and on the other hand of the first mass moment of inertia J₁, in the unit kg*m², is greater than or equal to 14037 N*m/(rad*kg*m²) and less than or equal to 49348 N*m/(rad*kg*m²). Thus, put into an equation the following applies:

14037 N*m/(rad*kg*m²)≦(c₁+c₂)/J₁≦49348 N*m/(rad*kg*m²),

wherein c₁ is the spring constant of the first energy accumulator means 38 [in the unit Nm/rad] and wherein c₂ is the spring constant of the second energy accumulator means 40 [in the unit Nm/rad] and wherein J₁ is the first mass moment of inertia [in the unit kg*m²]. The values or ranges however can be set in a manner as described elsewhere in the present disclosure.

In the embodiments according to FIGS. 2 through 4 it is furthermore respectively provided that the motor vehicle drive train 2, or the torque converter device 1 or the torsion vibration damper 10 are configured, so that the quotient, which is formed on the one hand from the sum (c₁+c_{GEW}) of the spring constant c₂ of the second energy accumulator means 40 [in the unit Nm/rad] and the spring constant c_{GEW} of the transmission input shaft 66 [in the unit Nm/rad] and on the other hand of the second mass moment of inertia J₂ [in the unit kg*m²], is greater than or equal to 1403677 N*m/(rad*kg*m²) and less or equal to 5614708 N*m/(rad*kg*m²). Thus, put into an equation, the following applies:

1403677 N*m/(rad*kg*m²)≦(c₂+c_{GEW})/J₂≦5614708 N*m/(rad*kg*m²),

wherein c₂ is the spring constant of the second energy accumulator means 40 [in the unit Nm/rad] and wherein c_{GEW} is the spring constant of the transmission input shaft 66 [in the unit Nm/rad], and wherein J₂ is the second mass moment of inertia [in the unit kg*m²]. The values or ranges however, can be comprised in a manner as it is described at another location of the present disclosure.

In the embodiments according to FIGS. 2 through 4 in particular, it can be provide that the first mass moment of inertia J₁ is substantially comprised of the mass moments of inertia of the following components: outer turbine dish 26 with extension 32, inner turbine dish 262, turbine blades or blading of the turbine or of the turbine shell 24, driver component 50 with housing 82 and housing cover 264, first component 46, first connection means 52 or 54, second connection means 56, slider dish(es) 94 or roller shoes 82, possibly a portion of the arc springs 42, possibly a portion of the compression springs 44, possibly a portion of the oil, or oil, which is included in the arc spring channel(s), and possibly a portion of the oil, or oil with reference to the turbines, or oil, which is in the turbine. The mass moments of inertia thus particularly relate to the rotation axis 36.

Furthermore it can be provided in the embodiments according to FIGS. 2 through 4, that the second mass moment of inertia J₂ is substantially comprised of the mass moments of inertia of the following components: flange or third component 62, hub 64, which furthermore can also be integrally provided with the flange 62, and possibly a portion of the transmission input shaft 66 and possibly a portion of the compression springs 44 and possibly a non-illustrated diaphragm spring for a controlled hysteresis, and possibly shaft retaining rings and/or seal elements.

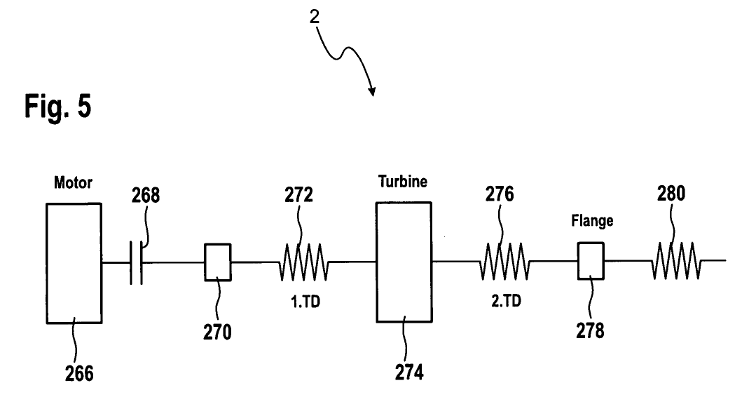

FIG. 5 shows a spring/rotating mass schematic of a component of an exemplary motor vehicle drive train 2 according to the invention, for example, the embodiment according to FIG. 1, comprising a configuration according to each of the embodiments shown in FIG. 2, FIG. 3, or FIG. 4 when the converter lockup clutch is closed.

The system can be considered in particular in an ideal manner as a series connection comprising a first engine side rotating mass 266, a clutch 268, a second rotating mass 270, connected at the input side of a first spring 272 between the clutch 268, and the first spring 272, a third rotating mass 274 connected between the first spring 272 and a second spring 276, the second spring 276 a fourth rotating mass 278, connected between the second spring 276 and a third spring 280.

The section formed by the series connection of the first spring 272, the third rotating mass 274, the second spring 276, the fourth rotating mass 278 and the third spring 280 thus forms from an ideal point of view a spring/rotating mass diagram for the first energy accumulator means 38, the connection of the first energy accumulator means 38 and the second energy accumulator means 40, the second energy accumulator means 40, the connection of the second energy accumulator means 40 to the transmission input shaft 66 and the transmission input shaft 66.

Subsequently, an exemplary improvement of the exemplary embodiments, advantages and effects according to the invention described supra based on figures, shall be described, which can be provided at least in an improved embodiment of the invention.

Quite frequently good or optimum insulation properties will be required, when the lockup clutch is completely closed in order to reach the goals of a lower and/or minimum fuel consumption or CO₂ output. It can thus be desirable that the goals are accomplished within a predetermined partial load range, in which the combustion engine is mostly operated. The insulation required for good sound and vibration comfort can be additionally accomplished under high loads, which do not occur that often and under full load, by means of an additional slipping lockup clutch.

The torque converter device 1 or the torque converter 1 comprising the torsion vibration damper or the energy accumulator devices 38, 40 constitutes a torsion vibration system in combination with the engine 250 and the drive train 2 of the vehicle. The natural modes of the torsion vibration system are induced due to the variations of the rotation of the combustion engine 250. Each natural mode of the system comprises an associated natural frequency. When the natural frequency coincides with the frequency of rotation of the combustion engine 250, the system vibrates in resonance, meaning at maximum amplitude. It is often useful to avoid high amplitudes, since they can cause disturbing vibrations and noises. The natural frequencies of the system depend on the torsion stiffnesses and rotating masses in the system. Therefore, the major components are in particular configured, so that between the torsion dampers or the energy accumulator means 38, 40 a large mass is created, or a large mass moment of inertia. On the other hand the major components between the lockup clutch and the torsion vibration damper, and those between torsion vibration damper and transmission input shaft are configured, so that the smallest masses possible are created in this location so that the natural frequencies of the system are thereby excited to a lesser extent in the operating range of the combustion engine 250. The insulation due to the support of the damper is performed between the primary side and the secondary side (=>turbine against the increased mass moment of inertia).

Through the arrangement of the double damper or of the torsion vibration damper 10, an improved insulation is accomplished at low speeds, when the clutch is closed through the low to medium stiffnesses of the outward positioned damper, or of the first energy accumulator means 38 and of the inner damper, connected in series, or of the second energy accumulator means 40.

At higher speeds, increased friction can lead to an increased stiffness of the outer damper or of the first energy accumulator means 38. Herein, the inner damper connected in series, or the second energy accumulator means 40 (in particular without friction), leads to more advantageous vibration characteristics in the upper speed range.

A significant improvement of the double damper or of the torsion vibration damper 10 is performed by the configuration of a torsion vibration damper or a energy accumulator means especially for partial load operation (lower torque), so that a very low spring stiffness of the torsion vibration damper or of the energy accumulator means can be realized in the range. Hereby, the reactive forces between the elastic element and the housing (dish) become smaller, furthermore, the mass of the spring element is smaller and thereby generates less centrifugal force and less friction relative to the housing (dish). This improves insulation. Through this measure, controlled two-mass inertia characteristics of the converter housing relative to the turbine are achieved.

Through the use of a sliding support or roller body support (slider shoe/ball screw shoe or roller shoe), the friction of the exterior elastic element, or of the first energy accumulators 42 over the complete speed range is reduced. Thereby an additional improvement of the insulation is accomplished in combination with the inner damper connected in series and the second energy accumulator means 40.

Thus it is seen that the objects of the invention are efficiently obtained, although changes and modifications to the invention should be readily apparent to those having ordinary skill in the art, which changes would not depart from the spirit and scope of the invention as claimed.

### DESIGNATIONS

1 hydrodynamic torque converter device
2 motor vehicle drive train
10 torsion vibration damper
12 converter torus
14 converter lockup clutch
16 converter housing
18 drive shaft like engine output shaft of a combustion engine
20 pump or pump shell
22 stator shell
24 turbine or turbine shell
26 outer turbine shell
28 torus interior
30 wall section of 26
32 extension at 30 of 26
34 straight section of 32 or annular disk shaped section of 32
36 rotation axis of 10
38 first energy accumulator means
40 second energy accumulator means
42 first energy accumulator
44 second energy accumulator
46 first component of 10
48 load transfer path
50 driver component
52 connection means or welded connection between 32 and 50 in 48
54 connection means or bolt or rivet connection between 32 and 50 in 48
56 connection means or bolt or rivet connection between 50 and 46 in 48
60 second component
62 third component
64 hub
66 output shaft, transmission input shaft
68 support section
72 first disk carrier of 14
74 first disk of 14
76 second disk carrier of 14
78 second disk of 14
79 disk packet of 14
80 piston for actuating 14
81 friction liner of 14
82 housing
84 roller shoe
86 lug
88 non-free end of 82
90 free end of 82
second rotation angle limiter means 92 of 40
slider shoe
250 combustion engine, 4-cylinder engine
252 cylinder of 250
254 transmission
256 transmission output shaft
258 differential
260 drive axle
262 inner turbine dish
264 cover
266 engine side rotating mass, first rotating mass
268 clutch
270 rotating mass of the connection, second rotating mass
272 first spring
274 rotating mass of the connection between 272 and 276, third rotating mass
276 second spring
278 rotating mass of the connection between 276 and 280, fourth rotating mass
280 third spring

1-7. (canceled)

8. A motor vehicle drive train comprising:
an four-cylinder combustion engine (250) comprising a maximum engine torque M_{mot,max};
an engine output shaft or a crank shaft (18);
a transmission input shaft (66);
a torque converter device (1) comprising a converter housing (16), a converter lockup clutch (14), a torsion vibration damper (10) and a converter torus (12), wherein said converter housing (16) is non-rotatably coupled to said engine output shaft or crank shaft (18), said converter torus (12) is formed by a pump shell (20), a turbine shell (24) and a stator shell (22);
said torsion vibration damper (10) comprises a first energy accumulator means (38), a second energy accumulator means (40) and a first component (46), wherein said first energy accumulator means (38) comprises at least one first energy accumulator (44) and said second energy accumulator means (40) comprises at least one second energy accumulator (44), said first energy accumulator means (38) connected in series with said second energy accumulator means (40), said first component (46) is arranged between and connected in series with said first energy accumulator means (38) and second energy accumulator means (40); and,
said turbine shell (24) comprises an outer turbine shell (26) non-rotatably connected to said first component (46); and,
wherein said torque converter device (1) further comprises a third component (62) non-rotatably coupled to said transmission input shaft (66), which in particular adjoins the torque converter device (1), and said third component (62) is connected in series with said second energy accumulator means (40) and said transmission input shaft (66), so that a torque can be transferred from said second energy accumulator means (40) through said third component (62) to said transmission input shaft (66);
wherein during a torque transfer through said first component (46), a change of said torque transferred through said first component (46) is counteracted by a first mass moment of inertia J₁, and during a torque transfer through said third component (62), a change of said torque transferred through said third component is counteracted by a second mass moment of inertia J₂;
wherein a spring constant c₁ [in the units of Nm/°] of said first energy accumulator means (38) is greater than or equal to a product of said maximum engine torque M_{mot,max}[in the units of Nm] of said four-cylinder combustion engine and a factor 0.014 [in the units of 1/°] and less than or equal to a product of said maximum engine torque M_{mot,max} [in the units of Nm] of said four-cylinder combustion engine and a factor 0.068 [in the units of 1/°];
wherein a spring constant c₂ [in the units of Nm/°] of said second energy accumulator (40) means is greater than or equal to a product of said maximum engine torque M_{mot,max} [in the units of Nm] of said four-cylinder combustion engine and a factor 0.035 [in the units of 1/°] and less than or equal to a product of said maximum engine torque M_{mot,max} [in the units of Nm] of said four-cylinder combustion engine and a factor 0.158 [in the units of 1/°];
wherein a quotient formed from a sum of said spring constant c₁ [in the units of Nm/rad] of said first energy accumulator means (38) and said spring constant c₂ [in the units of Nm/rad] of said second energy accumulator means (40) divided by said first mass moment of inertia J₁ [in the units of kg*m²] is greater than or equal to 14037N*m/(rad*kg*m²) and less than or equal to 49348 N*m/(rad*kg*m²); and,
wherein a quotient formed from a sum of said spring constant c₂ [in the units of 1/rad] of said second energy accumulator means and a spring constant C_{GEW} [in the units of 1/rad] of said transmission input shaft divided by said second mass moment of inertia J₂ [in the units of kg*m²] is greater than or equal to 1403677 N*m/(rad*kg*m²) and less than or equal to 5614708 N*m/(rad*kg*m²).

9. The motor vehicle drive train according to claim 8, wherein a spring constant c_{GEW} of the transmission input shaft (66) is in the range of 100 Nm/° to 350 NM/°.

10. The motor vehicle drive train according to claim 8, wherein the first energy accumulator means (38) comprises a plurality of first energy accumulators (42), said plurality of first energy accumulators (42) offset circumferentially relative to a circumferential direction of a rotation axis (36) of the torsion vibration damper (10) and connected in parallel.

11. The motor vehicle drive train according to claim 8, wherein at least one of said plurality of first energy accumulators (42) is a coil spring or an arc spring.

12. The motor vehicle drive train according to claim 8, wherein said second energy accumulator means (40) comprises a plurality of second energy accumulators (44), said plurality of second energy accumulators (44) offset circumferentially relative to a circumferential direction of a rotation axis (36) of the torsion vibration damper (10) and connected in parallel.

13. The motor vehicle drive train according to claim 8, wherein at least one of said plurality of said second energy accumulators (44) is a coil spring, a straight spring, or a compression spring.

14. A motor vehicle drive train comprising:
an four cylinder combustion engine (250) comprising a maximum engine torque M_{mot,max};
a torque converter device (1), comprising a converter lockup clutch (14) having a piston (80), a torsion vibration damper (10) and a converter torus (12), said converter torus (12) formed by a pump shell (20), a turbine shell (24) and a stator shell (22);
wherein the torsion vibration damper (10) includes:
a first energy accumulator means (38), comprising at least one first energy accumulator (42);
a second energy accumulator means (40), comprising at least one second energy accumulator (44) and which is connected in series with the first energy accumulator means (38);
a first component (46), said first component (46) arranged between and connected in series with said first energy accumulator means (38) and said second energy accumulator means (40);
wherein said turbine shell (24) includes an outer turbine dish (26), said outer turbine dish (26) nonrotatably connected to said first component (46) through a driver component (50);
wherein said driver component (50) and/or said first component (46) is configure d with a substantially thicker wall than said piston (80) and/or a substantially stiffer wall than said piston (80) forming an additional mass or forming a large mass moment of inertia J₁ acting between said first energy accumulator means (38) and said second energy accumulator means (40), and arranged for torque transfer through said first component (46) and/or through said driver component (50.

15. The motor vehicle drive train according to claim 14 wherein said first component is a plate.

16. The motor vehicle drive train according to claim 14 wherein said driver component is a plate.

17. The motor vehicle drive train according to claim 14 wherein said substantially thicker wall is at least twice as thick, at least three times as thick, at least five times as thick, at least ten times as thick or at least twenty times as thick as said piston (80).

18. The motor vehicle drive train according to claim 14 wherein said substantially stiffer wall is at least twice as stiff, at least three times as stiff, at least five times as stiff, at least ten times as stiff or at least twenty times as stiff as said piston (80).
